(19) United States
(12) Patent Application Publication
(10) Pub. No.: US 2009/0039053 A1
(43) Pub. Date: Feb. 12, 2009

(54) METHOD FOR MANUFACTURING ELECTRICAL TRACES OF PRINTED CIRCUIT BOARDS

(75) Inventors: TSO-HUNG YEH, Tayuan (TW); CHIH-LUNG HSIAO, Tayuan (TW); HUNG-YI CHANG, Tayuan (TW)

Correspondence Address: PCE INDUSTRY, INC.;ATT. CHENG-JU CHIANG, 458 E. LAMBERT ROAD, FULLERTON, CA, 92835, US

(73) Assignee: FOXCONN ADVANCED TECHNOLOGY INC., Tayuan (TW)

(21) Appl. No.: 11/964,583

(22) Filed: Dec. 26, 2007

(30) Foreign Application Priority Data
Aug. 8, 2007 (CN) 200710075642.8

(51) Int. Cl. H01B 13/00

(52) U.S. Cl. 216/13

(57) ABSTRACT

An exemplary method for manufacturing a printed circuit board is provided. Firstly, a copper clad substrate comprising a base film, a copper layer and intermediate layer interposed between the base film and the copper layer is provided. The intermediate layer is comprised of nickel, chromium, or alloy of nickel and chromium. A patterned photoresist layer is formed on the copper layer with portions of the copper layer are exposed from the photoresist pattern layer. Exposed portions of the copper layer are removed using a copper etchant to form a number of electrical traces, thereby exposing portions of the intermediate layer from the patterned photoresist layer. Exposed portions of the intermediate layer are removed using a chromium-nickel etchant. The method can prevent a bottom of each of electrical traces from enlarging, thereby improving quality of printed circuit board.

### BACKGROUND

1. Technical Field

The present invention relates to printed circuit boards, and particularly to a method for manufacturing electrical traces of printed circuit boards.

2. Description of Related Art

Currently, a flexible substrate without adhesive for manufacturing a flexible printed circuit board includes a flexible insulating layer and an electrically conductive layer formed on the flexible insulating layer. The flexible insulating layer is often a polyimide layer and the electrically conductive layer is often a copper layer. In order to improve adhesion between the polyimide layer and the copper layer, an intermediate layer composed of nickel, chromium or nickel-chromium alloy is often interposed between the polyimide layer and the copper layer.

Generally, electrical traces of the flexible printed circuit board are manufactured using a typical photolithographic process, which includes the steps of applying a photoresist layer on the copper layer, exposing and developing the photoresist layer, etching the copper layer exposed from the photoresist layer and removing the residual photoresist layer. However, in the photolithographic process, the etching step is performed only once. Referring to FIG. 8, during etching the copper layer using a copper etchant, nickel, chromium or nickel-chromium alloy of an intermediate layer 12 on two sides of a bottom of each of the electrical traces 11 can not be etched and removed completely because of lower reacting efficiency of the copper etchant at these portions. Thus, nickel, chromium or nickel-chromium alloy of the intermediate layer 12 remaining on two sides of the bottom of each of the electrical trace 11 will increase a width of the bottom of each of the electrical traces 11. Nowadays, in order to accommodate electronic products with high-density interconnection, fine-pitch electrical traces of printed circuit boards have become more and more popular. Therefore, a shortage of circuits between two neighboring electrical traces may occur using the method described above to manufacture fine-pitch electrical traces, thereby affecting quality of printed circuit boards.

What is needed, therefore, is a method for manufacturing electrical traces of printed circuit boards, thereby improve quality of printed circuit boards.

### SUMMARY

One preferred embodiment includes method for manufacturing a printed circuit board. Firstly, a copper clad substrate comprising a base film, a copper layer and intermediate layer interposed between the base film and the copper layer is provided. The intermediate layer is comprised of nickel, chromium, or alloy of nickel and chromium. A patterned photoresist layer is formed on the copper layer with portions of the copper layer exposed from the patterned photoresist layer. Exposed portions of the copper layer are removed using a copper etchant to form a number of electrical traces, thereby exposing portions of the intermediate layer from the patterned photoresist layer. The exposed portions of the intermediate layer are removed using a chromium-nickel etchant.

### BRIEF DESCRIPTION OF THE DRAWINGS

Many aspects of the present method can be better understood with reference to the following drawings. The components in the drawings are not necessarily drawn to scale, the emphasis instead being placed upon clearly illustrating the principles of the present method. Moreover, in the drawings, like reference numerals designate corresponding parts throughout the several views.

FIG. 1 is a flow chart of a method for manufacturing electrical traces of a printed circuit board according to a present embodiment.

FIG. 2 is a schematic, cross-sectional view of a copper clad substrate for manufacturing electrical traces of the printed circuit board according to the present embodiment.

FIG. 3 is a schematic, cross-sectional view of the copper clad substrate having a photoresist layer formed thereon.

FIG. 4 is a schematic, cross-sectional view of the copper clad substrate having a patterned photoresist layer formed thereon.

FIG. 5 is a schematic, cross-sectional view of the copper clad substrate in FIG. 4 that is etched using a copper etchant.

FIG. 6 is a schematic, cross-sectional view of the copper clad substrate in FIG. 5, from which the photoresist pattern layer is removed.

FIG. 7 is a schematic, cross-sectional view of the copper clad substrate in FIG. 6 that is etched using a chromium-nickel etchant.

FIG. 8 is a schematic, cross-sectional view of electrical traces of a printed circuit board formed using a typical method.

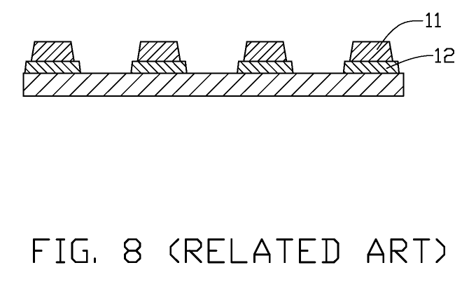

### DETAILED DESCRIPTION OF THE EMBODIMENTS

Embodiment will now be described in detail below with reference to the drawings.

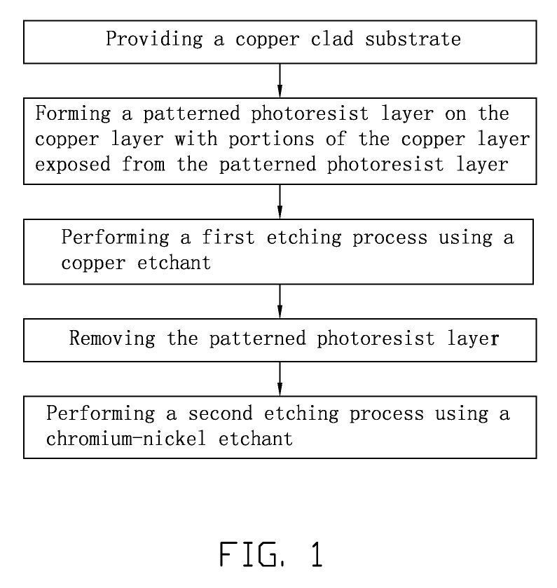

Referring to FIG. 1, an exemplary method for manufacturing electrical traces of a printed circuit board includes the steps of: providing a copper clad substrate; forming a patterned photoresist layer on at least one surface of the copper clad substrate; performing a first etching process using a copper etchant; removing the patterned photoresist layer; and performing a second etching process using a chromium-nickel etchant. The method for manufacturing electrical traces of a printed circuit board will be described in detail.

Step 1: a copper clad substrate 20 is provided.

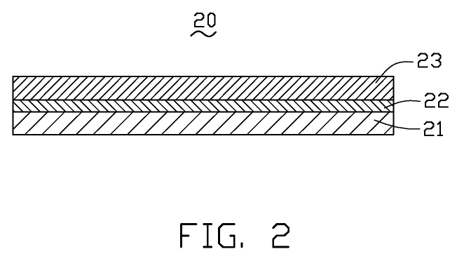

Referring to FIG. 2, the copper clad substrate 20 is a single-side copper clad substrate and is ready for manufacturing electrical traces, and further being made into a printed circuit board. The copper clad substrate 20 includes a base film 21, an intermediate layer 22 and a copper layer 23. The intermediate layer 22 is interposed between the base film 21 and the copper layer 23.

The base film 21 can either be a single layer structure including an insulating film or a multilayer structure containing a number of insulating films and a number of electrical circuit layer arranged alternately. When the base film 21 is the single layer structure, the base film 21 can be made of a material selected from a group consisting of polyimide, polyester, polytetrafluoroethylene, polymethyl methacrylate and polycarbonate. When the base film 21 is the multilayer structure, an outmost layer of the multilayer structure should be an insulating film so as to the intermediate layer 22 can be interposed between the outmost insulating film of the base film 21 and the copper layer 23. In the present embodiment, the base film 21 is a single layer polyimide film.

The intermediate layer 22 interposed between the base film 21 and the copper layer 23 is configured for improving adhesion between the base film 21 and the copper layer 23. The intermediate layer 22 can be comprised of nickel, chromium, or alloy of nickel and chromium. The intermediate layer 22 can be deposited on the base film 21 by a sputtering process.

The copper layer 23 can be formed on the intermediate layer 22 by a sputtering process or an electroplating process.

It is understood that the copper clad substrate for manufacturing electrical traces can be a double-sides copper clad substrate. Two intermediate layers can be respectively formed on two opposite sides of the base film, and then two copper layers can be respectively formed on the two intermediate layers. Thus, electrical traces can be formed on two opposite sides of the copper clad substrate.

Step 2: a patterned photoresist layer 24b is formed on the copper layer 23 with portions of the copper layer exposed from the patterned photoresist layer 24b.

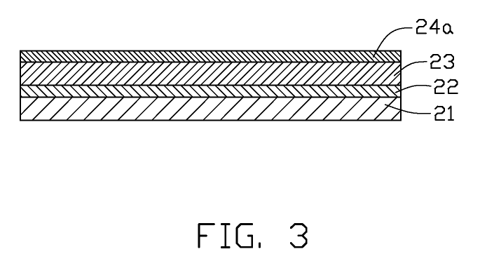

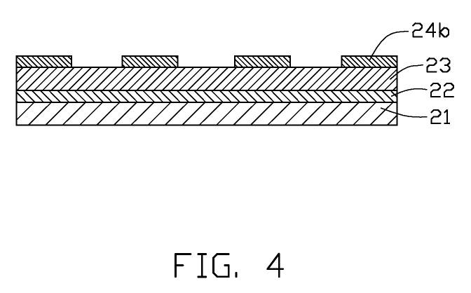

Firstly, referring to FIG. 3, a photoresist layer 24a is applied onto a surface of the copper layer 23. The photoresist layer 24a can either be a liquid photoresist layer or a dry film photoresist layer. The photoresist layer 24a can either be a positive photoresist layer or a negative photoresist layer. In the present embodiment, the photoresist layer 24a is a positive dry film photoresist layer. Secondly, referring to FIG. 4, the photoresist layer 24a is exposed and developed to form a patterned photoresist layer 24b. Thus, portions of the copper layer 23 are exposed from the patterned photoresist layer 24b. Portions of the copper layer 23 exposed from the patterned photoresist layer 24b will be removed in the following etching processes, thus residual portions of the copper layer 23 covered by the patterned photoresist layer 24b will form a patterned copper layer, i.e., a desired electrical traces.

Step 3: a first etching process is performed using a copper etchant.

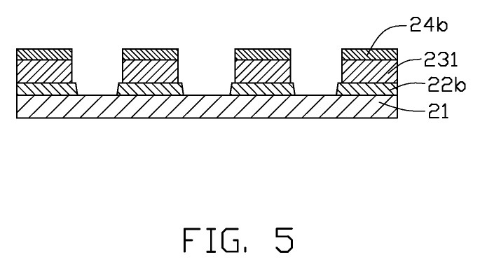

Referring to FIG. 5, in the first etching process, the copper etchant etches the corresponding portions of the copper layer 23 so as to remove portions of the copper layer 23 exposed from the patterned photoresist layer 24b. In the present embodiment, the copper ethcant is an acidic copper chloride solution including copper chloride(CuCl₂), hydrochloric acid (HCl) and peroxide (H₂O₂). It is understood that other suitable copper ethcant can also be used, for example, an acidic iron chloride solution. In the first etching process, portions of the copper layer 23 of the copper clad substrate 20 exposed from the patterned photoresist layer 24b are etched by the copper ethcant and removed from the copper clad substrate 20, and residual portions of the copper layer 23 covered by the patterned photoresist layer 24b form the patterned copper layer including a number of electrical traces 231.

Furthermore, portions of the copper layer 23 on the intermediate layer 22 are etched by the copper ethcant and removed from the copper clad substrate 20, thus portions of the intermediate layer 22 is exposed from the patterned photoresist layer 22b. Portions of the intermediate layer 22 exposed from the patterned photoresist layer 22b can also be etched by the copper ethcant and removed from the copper clad substrate 20 partially. It is noted that an etching reaction may not occur between the copper ethcant and the portions of the intermediate layer 22 exposed from the patterned photoresist layer 22b due to properties of the copper etchant. In the present embodiment, the acidic copper chloride etchant will partially etch and remove portions of the intermediate layer 22 exposed from the electrical traces 231, thereby forming a patterned intermediate layer 22b. That is, nickel, chromium or nickel-chromium alloy of the intermediate layer 22 on a bottom of each of the electrical traces 231 and on two sides of the bottom of each of the electrical traces 231 are remained.

Step 4: the patterned photoresist layer 24b is removed.

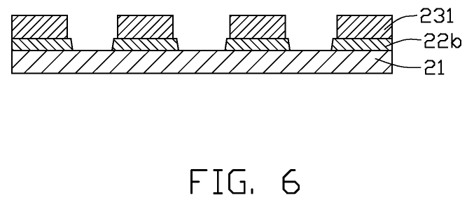

Referring to FIG. 6, the patterned photoresist layer 24b is removed so as to expose the electrical traces 231. Generally, the patterned photoresist layer 24b can be removed using an alkaline solution such as a sodium carbonate solution with concentration form 2% to 5%, a sodium hydroxide solution with concentration form 2% to 5% and a potassium hydroxide solution with concentration form 2% to 5%. In the present embodiment, the sodium carbonate solution with concentration form 2% to 5% is used to remove the patterned photoresist layer 24b. Because the patterned photoresist layer 24b is formed with the positive photoresist, it is necessary to irradiate the patterned photoresist layer 24b with an ultraviolet light. Thus, the patterned photoresist layer 24b can be dissolved in the sodium carbonate solution so as to expose the electrical traces 231. It is understood that if the patterned photoresist layer 24b is formed with the negative photoresist, it is unnecessary to irradiate the patterned photoresist layer 24b with an ultraviolet light. Similarly, the patterned photoresist layer 24b can be dissolved in the sodium carbonate solution so as to expose the electrical traces 231.

Step 5: a second etching process is performed using a chromium-nickel etchant.

Before the second etching process is performed, a cleaning step is advantageously performed after the patterned photoresist layer 24b is removed in order to remove the residual alkaline solution on the electrical traces 231. The residual alkaline solution on the electrical traces 231 can be removed by washing in acid such as hydrochloric acid with concentration form 3% to 6% or in water such as distilled water.

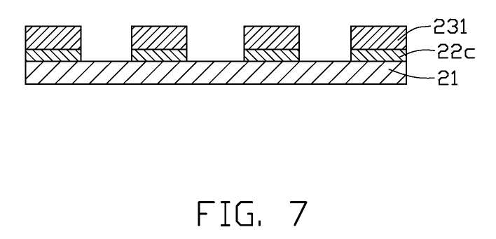

Referring to FIG. 7, in the second etching process, the chromium-nickel etchant etches portions of the intermediate layer 22b exposed from the electrical traces 231 after the first etching process, i.e., nickel, chromium or nickel-chromium alloy of the intermediate layer 22 on two sides of a bottom of each of the electrical traces 231, thereby forming the intermediate layer 22c. In the present embodiment, the chromium-nickel ethcant can includes sulfuric acid (H₂SO₄), hydrochloric acid (HCl), a restraining component for restraining etching of copper, and water. The restraining component can either be a compound containing at least one of sulfur, amido, sub-amido, carboxyl, carbonyl, or a compound containing thiazolodin or the like. Due to the restraining component in the chromium-nickel ethcant, the chromium-nickel ethcant cannot etch the electrical traces 231 excessively, however, a micro-etching process can occur on surfaces of the electrical traces 231 to increase roughness of the surfaces of the electrical traces 231. Therefore, only portions of the intermediate layer 22b exposed from the electrical traces 231 are etched by the chromium-nickel etchant.

Additionally, the following steps including applying a solder resist layer on a side of the copper clad substrate having the electrical traces 231 thereon, electroplating gold on the terminals, printing legend on the solder resist layer, and so on, can be performed selectively, and thus a printed circuit board is obtained. The method described above can prevent the bottom of each of the electrical traces 231 from increasing, thereby improving quality of printed circuit board.

It is noted that the patterned photoresist layer 24b can be removed after the second etching process is performed. Because the patterned photoresist layer 24b is still remained on the electrical traces 231, the patterned photoresist layer 24b can prevent the electrical traces 231 from etching. Thus, the chromium-nickel ethcant can etch nickel, chromium or nickel-chromium alloy of the intermediate layer 22b remained on two sides of the bottom of each of the electrical traces 231 without the restraining component.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A method for manufacturing a printed circuit board, comprising the steps of:
providing a copper clad substrate comprising a base film, a copper layer and intermediate layer interposed between the base film and the copper layer, the intermediate layer being comprised of nickel, chromium, or an alloy of nickel and chromium;
forming a patterned photoresist layer on the copper layer with portions of the copper layer exposed from the patterned photoresist layer;
removing exposed portions of the copper layer using a copper etchant to form a plurality of electrical traces, thereby exposing portions of the intermediate layer from the patterned photoresist layer; and
removing the exposed portions of the intermediate layer using a chromium-nickel etchant.

2. The method as claimed in claim 1, wherein before the step of removing the exposed portions of the intermediate layer, the patterned photoresist layer is removed using an alkaline solution.

3. The method as claimed in claim 2, wherein the alkaline solution is selected from a group consisting of a sodium carbonate solution with concentration from 2% to 5%, a sodium hydroxide solution with concentration from 2% to 5% and a potassium hydroxide solution with concentration from 2% to 5%.

4. The method as claimed in claim 3, wherein after the step of removing the exposed portions of the intermediate layer, the patterned photoresist layer is removed using an alkaline solution.

5. The method claimed in claim 4, wherein the alkaline solution is selected from a group consisting of a sodium carbonate solution with concentration from 2% to 5%, a sodium hydroxide solution with concentration from 2% to 5% and a potassium hydroxide solution with concentration from 2% to 5%.

6. The method as claimed in claim 4, wherein a cleaning step is performed after the patterned photoresist layer is removed to remove the residual alkaline solution on the electrical traces.

7. The method claimed in claim 1, wherein the base film is a single layer structure comprising an insulating film.

8. The method as claimed in claim 7, wherein the insulating film is comprised of a material selected from a group consisting of polyimide, polyester, polytetrafluoroethylene, polymethyl methacrylate and polycarbonate.

9. The method as claimed in claim 7, wherein the base film is a multilayer structure comprising a plurality of insulating films and a plurality of electrical circuit layers arranged alternately, the intermediate layer is interposed between an outmost insulating film of the base film and the copper layer.

10. The method as claimed in claim 1, wherein the copper etchant is either an acidic copper chloride solution or an acidic iron chloride solution.

11. The method as claimed in claim 1, wherein the chromium-nickel etchant comprises sulfuric acid, hydrochloric acid and water.

12. The method as claimed in claim 11, wherein the chromium-nickel etchant further comprises a restraining component for restraining etching of copper.

13. The method as claimed in claim 12, wherein the restraining component for restraining etching of copper is a compound comprising at least one of sulfur, amido, sub-amido, carboxyl, carbonyl.

14. The method as claimed in claim 12, wherein a compound the restraining component for restraining etching of copper is thiazolodin.
